(19) United States
(12) Patent Application Publication
(10) Pub. No.: US 2011/0254452 A1
(43) Pub. Date: Oct. 20, 2011

(54) GAS DISCHARGE LAMPS

(76) Inventors: Jens-Peter Kunzmann, Berlin (DE); Bernhard Pfeiffer, Berlin (DE); Phillip Foxley, N. Wales (GB); Edwin Maurer, Rosmalen (NL); Guodo Hheremans, Wolfsdonk-Langdorp (BE); Payl Clarke, Essex (GB); Melvyn Mcgann, Essex (GB)

(21) Appl. No.: 12/668,275

(22) PCT Filed: Jul. 8, 2008
(86) PCT No.: PCT/GB2008/002334

§ 371 Date: Apr. 29, 2011

(30) Foreign Application Priority Data
Jul. 9, 2007 (GB) 0713241.8

(51) Int. Cl. H05B 41/288; H05B 41/36; H05B 41/04

(52) U.S. Cl. 315/135; 315/200 R; 315/186; 315/276

(57) ABSTRACT

An electronic ballast (10), for a gas discharge lamp (18), comprises a constant current source (14) and a switch (16). A transformer (60), for use in an igniter (90) for a gas discharge lamp (18, 40), comprises a core (62) which has interconnected legs (64, 66, 68), a first secondary winding (70) around a first leg (64), a second secondary winding (72) around a second leg (66), and a primary winding (74) around a third leg (66). An igniter (90) for a gas discharge lamp (18, 40) comprises a transformer (60) as described above and a drive circuit (92) for driving the primary winding (74). The first and second secondary windings (70, 72) of the transformer (60) are electically couplable in series with a discharge lamp (18, 40)

This invention relates to gas discharge lamps, particularly high intensity discharge (HID) lamps, and more specifically to an electronic ballast for a gas discharge lamp, a transformer for use in an igniter for a gas discharge lamp, an igniter for a gas discharge lamp, and a gas discharge lamp assembly.

In the field of street or area lighting it is known to employ gas discharge lamps such as, but not limited to, high pressure sodium lamps. Such devices are desirable because of their high luminous efficiency values.

The gas discharge lamp is driven by a control gear which includes a ballast and an igniter. During use the discharge lamp exhibits a negative resistance characteristic, and so the ballast is required to condition the electrical power supplied to the discharge lamp in order to avoid a cascading discharge of the lamp.

A two-stage process is used to light a discharge lamp. During a first, ignition stage the igniter applies a high voltage (typically up to 5000V for a cold lamp and up to 25000V for a hot lamp) across the discharge lamp to establish an arc. In conventional arrangements, once an arc is established the ballast supplies an operating voltage to the discharge lamp to light the lamp.

It is known to attempt to have the ballast supply the discharge lamp with a constant current square wave having a peak-to-peak voltage essentially equal to the normal operating voltage of the discharge lamp.

One ballast arrangement that attempts to supply such a constant current square wave includes a constant current source which is electrically coupled to a discharge lamp by a coupling transformer having primary and secondary windings. Current flows alternatively along a first portion of the primary winding to induce a first current having a first polarity in the secondary winding, and along a second portion of the primary winding to induce a second current having a second polarity, opposite the first sense, in the secondary winding. In this way a current waveform approximating a square wave is induced in the secondary winding.

However, one drawback with this arrangement is the introduction of delays in the inducing of first and second currents in the secondary winding by the transformer. As a result there is a delay in the transition between first and second currents in the current waveform induced in the secondary winding, and so the current supplied to the discharge lamp includes a net direct current which varies with time. This can lead to deionisation of the discharge lamp when operated at a low frequency or a low power.

According to a first aspect of the invention there is provided an electronic ballast, for a gas discharge lamp, comprising a unidirectional power conditioner including a constant current source and a switch, the switch being electrically couplable directly with at least one discharge lamp to selectively direct current from the constant current source through the or each discharge lamp in a first direction and a second direction, the first and second directions being opposite one another.

The inclusion of a switch to selectively direct current through the or each discharge lamp allows for switching of the current flow between the first and second directions in typically 15 ns, and in some cases less than 10 ns. This essentially instantaneous switching of the current flow between first and second directions results in the current supplied to the or each discharge lamp being substantially continuous and having no net direct current component.

This prevents deionisation of a discharge lamp when operated in lower power condition, and so allows the discharge lamp to be dimmed without causing the lamp to extinguish.

Preferably the switch defines a first conducting path through which the current flows in the first direction and a second conducting path through which the current flows in the second direction.

First and second conducting paths assists in providing the essentially instantaneous switching mentioned above.

Optionally each conducting path includes a pair of series connected one-way switching devices. Such devices are available with high voltage and current ratings, and are able to switch quickly, typically less than 10 to 15 ns, between “on” (conductive) and “off” (non-conductive) states.

In a preferred embodiment of the invention each one-way switching device includes a Field Effect Transistor (FET).

In another preferred embodiment of the invention each one-way switching device includes an Insulated Gate Bipolar Transistor (IGBT).

Such devices advantageously have the necessary voltage and current ratings, and offer a sufficiently rapid switching speed.

Conveniently the one-way switching devices are arranged in a H-bridge configuration to which the or each discharge lamp is directly couplable so as to bridge the first and second conducting paths. Such an arrangement provides the desired first and second conducting paths in a compact and readily implementable form.

Optionally the power conditioner includes a power converter circuit to convert an alternating current into a direct current. The inclusion of such a power converter allows the ballast to run on an oscillating voltage supply, such as mains voltage.

In a further preferred embodiment of the invention the power converter circuit further includes an energy store. An energy store ensures that the current from the constant current source remains substantially constant and omits any oscillatory components of an oscillating voltage supply.

Preferably the power converter circuit further includes a power factor correction circuit. The inclusion of a power factor correction circuit helps to ensure that any supply voltage receives optimal loading so as to optimise the overall efficiency of the ballast.

The electronic ballast may further include a controller to control at least one of:
(i) the magnitude of the current provided by the constant current source; and
(ii) the frequency at which the switch switches between directing the current through the or each discharge lamp in the first and second directions.

The ability to control the magnitude of the current provided by the constant current source allows the ballast to accommodate any changes in the resistance of the or each discharge lamp while maintaining the power, i.e. brightness, of the or each discharge lamp at a constant level. In this way the ballast is able to improve the correlated colour temperature (CCT) and the colour rendering index (CRI) of the or each discharge lamp.

Optionally the controller is driven by a modular control algorithm.

The modular control algorithm may include first and second parts, the first part relating to generic control functions, and the second part relating to discharge lamp specific control functions.

Such an arrangement allows for the production of a range of differing electronic ballasts which may similarly tested by activating the generic control functions, but which can then quickly be modified to a specific application by adding a given second part corresponding to the desired lamp functionality.

Preferably the controller includes a voltage measurement device to measure the voltage across the or each discharge lamp, and a current measuring device to measure the current supplied to the or each discharge lamp.

The controller may further include a power calculator to calculate the average power dissipated in the or each lamp, a comparator for comparing the average power of the or each lamp with a required lamp power, the controller adjusting the magnitude of the lamp current to achieve the required lamp power.

Such features allow the ballast to maintain the power supplied to the or each discharge lamp at a desired level by adjusting the magnitude of the current supplied to the or each discharge lamp.

In addition, measuring the voltage across the or each discharge lamp allows for individual monitoring of the characteristics of each discharge lamp. As a result it is possible to take remedial action, such as short-circuiting a discharge lamp that extinguishes, so that other discharge lamps connected in series will continue to operate.

Optionally the controller includes a frequency controller to control the frequency at which the switch switches between directing the current through the or each discharge lamp in the first and second directions. The ability to control the switching frequency allows the current supplied to the or each discharge lamp to act as a signal to, e.g. an igniter, thereby obviating the need for a further signal line to control the igniter.

Conveniently but not essentially the frequency controller causes the switch to switch at a frequency falling within the range 5 Hz to 300 Hz.

In a further preferred embodiment of the invention the frequency controller causes the switch to switch at a first lower frequency, and a second higher frequency. The switching of the switch at two such frequencies allows the current supplied to the or each discharge lamp to carry a binary signal which could be used to turn a device “on” or “off”.

Preferably the lower frequency is in the range of 5 to 6 Hz, and the higher frequency is in the range 20 to 300 Hz. Discrete frequency ranges spaced from one another in this manner allow a receiver readily to discriminate between the two, e.g. “on/off” signals carried by the current supplied to the or each discharge lamp.

Optionally the electronic ballast includes an indicator to indicate an operational status of the ballast. The provision of such an indicator allows a user to observe the stages of operation of the ballast, such as the ignition, lamp heating up, or normal running stage, and so helps in diagnosing faults with a discharge lamp assembly.

Preferably the indicator includes a visual indicator.

A visual indicator is able readily to convey an operational status to a user by, for example its colour or its pulsing frequency.

According a second aspect of the invention there is provided a transformer, for use in an igniter for a gas discharge lamp, comprising:
a core having interconnected legs, each leg comprising a magnetic circuit;
a first secondary winding around a first leg;
a second secondary winding around a second leg; and
a primary winding around a third leg,
the primary winding being positioned relative to the first and second secondary windings such that flux from the primary winding divides between the first and second legs and flows in a direction in each of the first and second legs such that when the first and second secondary windings are connected in series via a series connection the resulting secondary voltages add, and when a current is supplied externally to the said series connection, fluxes in the first and second legs cancel, thereby reducing the effective inductance of the first and second secondary windings relative to that of each secondary winding taken separately.

Summing of the secondary voltages provides a desired high-voltage pulse across a discharge lamp which can be used to establish an arc when, for example, a suitable drive signal is applied to the primary winding.

Reducing the effective inductance of the first and secondary windings is desirable because this minimises the effect of the first and secondary windings on the current supplied to, e.g. a discharge lamp connected thereacross, and so helps in maintaining the power, i.e. brightness, of the discharge lamp at a desired, constant level.

Preferably the first secondary winding is wound in an opposite sense to the second secondary winding. This causes the flux flowing in the first leg to flow in an opposite direction to the flux flowing in the second leg, thereby providing the desired voltage-summing and inductance-reducing effects mentioned above according to the operating configuration of the transformer.

Optionally the transformer comprises printed windings forming a multilayer PCB, each layer of the multilayer PCB having a first, second and third aperture through which the first, second and third legs of the core respectively pass.

According to a third aspect of the invention there is provided an igniter for a gas discharge lamp comprising a transformer as described hereinabove and a drive circuit for driving the primary winding, the first and second secondary windings of the transformer being electrically couplable in series with a discharge lamp.

The first and second secondary windings being electrically couplable in series with a discharge lamp means that during normal operation of the discharge lamp in the current supplied to the discharge lamp is able to cause the fluxes in the first and second legs to cancel, and so produce the desired reduction in the effective inductance of the first and second secondary windings.

Moreover, the igniter is able to supply a high-voltage ignition pulse to establish an arc across the discharge lamp during an ignition stage.

According to a fourth aspect of the invention there is provided a gas discharge lamp assembly comprising an electronic ballast as described hereinabove electrically coupled directly with at least one discharge lamp, the or each discharge lamp having a corresponding igniter electrically coupled therewith.

Such an arrangement shares the advantages associated with the aforementioned electronic ballast.

Preferably the electronic ballast is electrically coupled to a plurality of series-connected discharge lamps. The provision of a constant current source ensures that the current supplied to each discharge lamp is substantially independent of the voltage across a given discharge lamp, and so it is possible to drive more than one discharge lamp. As a result it is possible to drive a plurality of discharge lamps in a compact and efficient manner.

Optionally the electronic ballast and the or each discharge lamp are arranged adjacent to one another. Such an arrangement allows for placement of the ballast and the or each discharge lamp in the same location such as, for example, within a luminaire at the top of a column or post.

In another embodiment of the invention the electronic ballast and the or each discharge lamp are spaced from one another. Such an arrangement provides flexibility in the placement of the ballast relative to the discharge lamp allowing, for example, placement of the ballast within a column or post having a discharge lamp at the end thereof.

In a further preferred embodiment of the invention the gas discharge lamp assembly includes a frequency discriminator to sense the frequency at which the switch is switching the current supplied by the constant current source and activate the or each igniter only when a desired switching frequency is sensed. The inclusion of a frequency discriminator allows for a decoding of, e.g., a binary signal carried by the current supplied to the or each discharge lamp.

The gas discharge lamp assembly may further include an ingniter controller to inhibit ignition of a discharge lamp until lapse of a predetermined time interval after prior extinguishing of the discharge lamp. These features prevent attempted reignition of a discharge lamp that is too hot to ignite, and thereby reduces the risk of damaging electrodes within the discharge lamp.

Optionally the or each igniter is an igniter as described hereinabove.

According to a fifth aspect of the invention there is provided a modular control gear for a gas discharge lamp comprising a plurality of components, each of the components being contained within an individual housing having at least one connector, the or each connector of one housing being mutually engagable with a corresponding connector of another housing, whereby one component is electrically couplable with another component to form a desired control gear for controlling a gas discharge lamp.

The foregoing features allow for the provision of a control gear that is readily configurable according to particular system requirements by selecting the desired components for inclusion in the control gear and coupling them to one another.

Preferably each housing includes an indicator to indicate an operational status of the component contained therein. The provision of such an indicator allows a user to observe the operation status of a given component, and so help in diagnosing any faults with a control gear.

Preferably each indicator includes a visual indicator. A visual indicator is able readily to convey an operational status to a user by, for example its colour or its pulsing frequency.

There now a brief description of preferred embodiments of the invention, by way of non-limiting example, with reference being made to the accompanying drawings, in which:

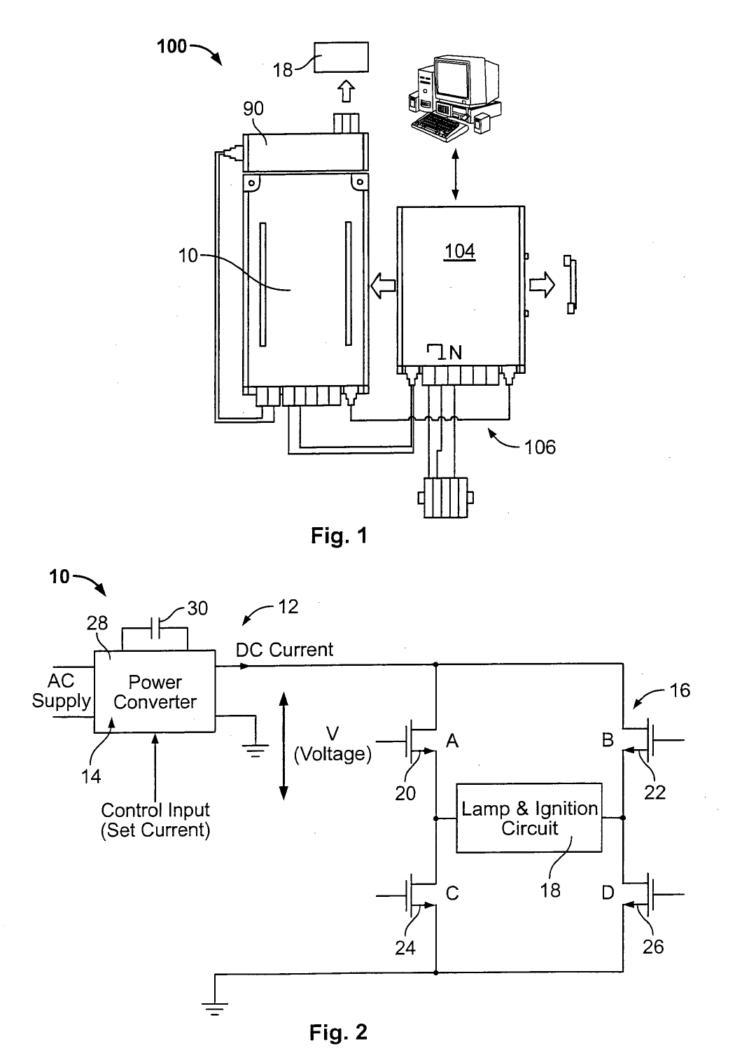

FIG. 1 shows a schematic view of a gas discharge lamp assembly;

FIG. 2 shows a schematic view of an electronic ballast according to a first embodiment of the invention;

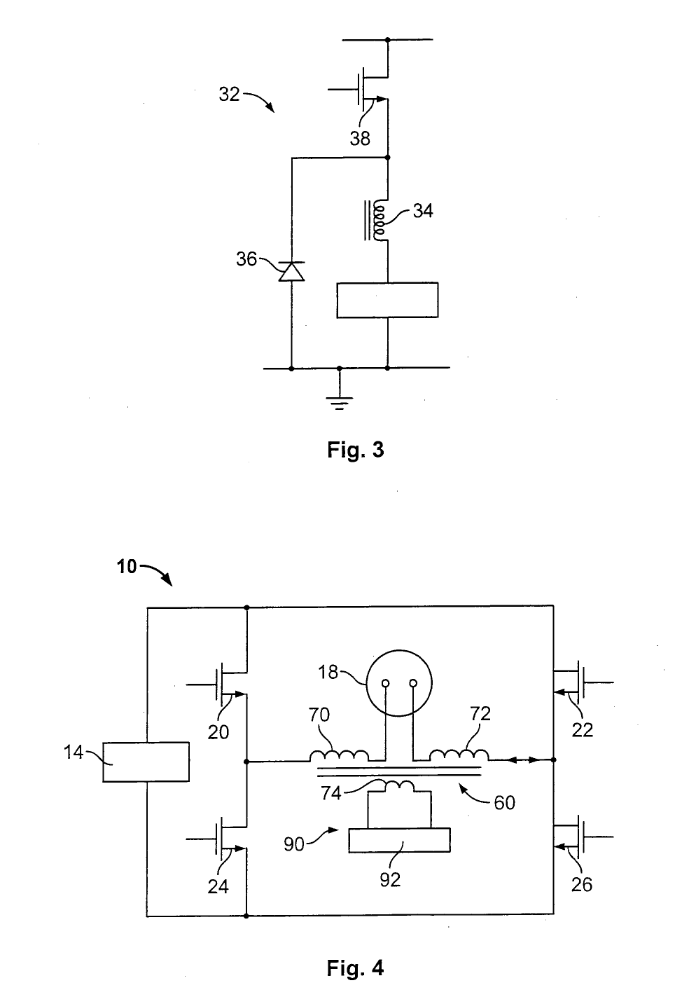

FIG. 3 shows a schematic view of a typical constant current source circuit;

FIG. 4 shows an enlarged view of a portion of the electronic ballast shown in FIG. 2 in a first configuration;

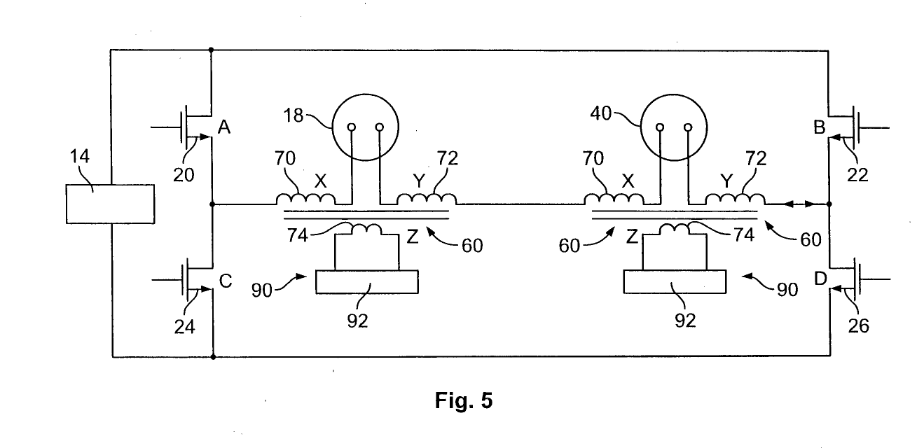

FIG. 5 shows a schematic view of the electronic ballast shown in FIG. 4 in a second configuration;

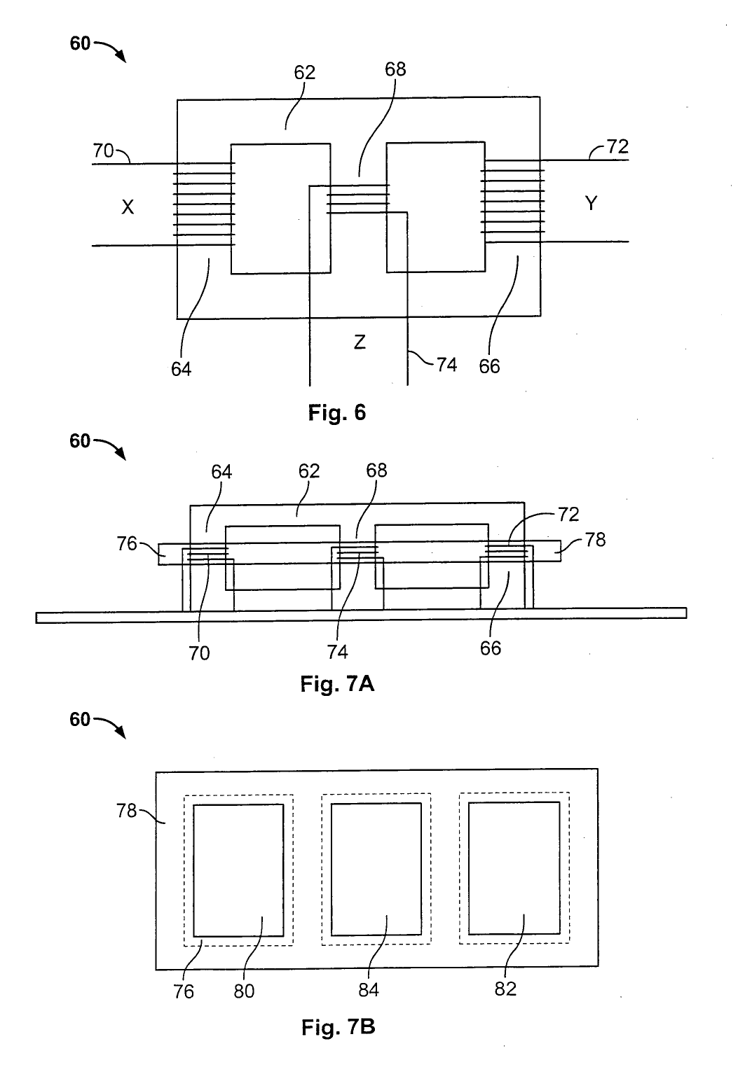

FIG. 6 shows a schematic view of a transformer according to a second embodiment of the invention;

FIG. 7(a) shows an elevational view of the transformer shown in FIG. 6;

FIG. 7(b) shows an plan view from above of the transformer shown in FIG. 6;

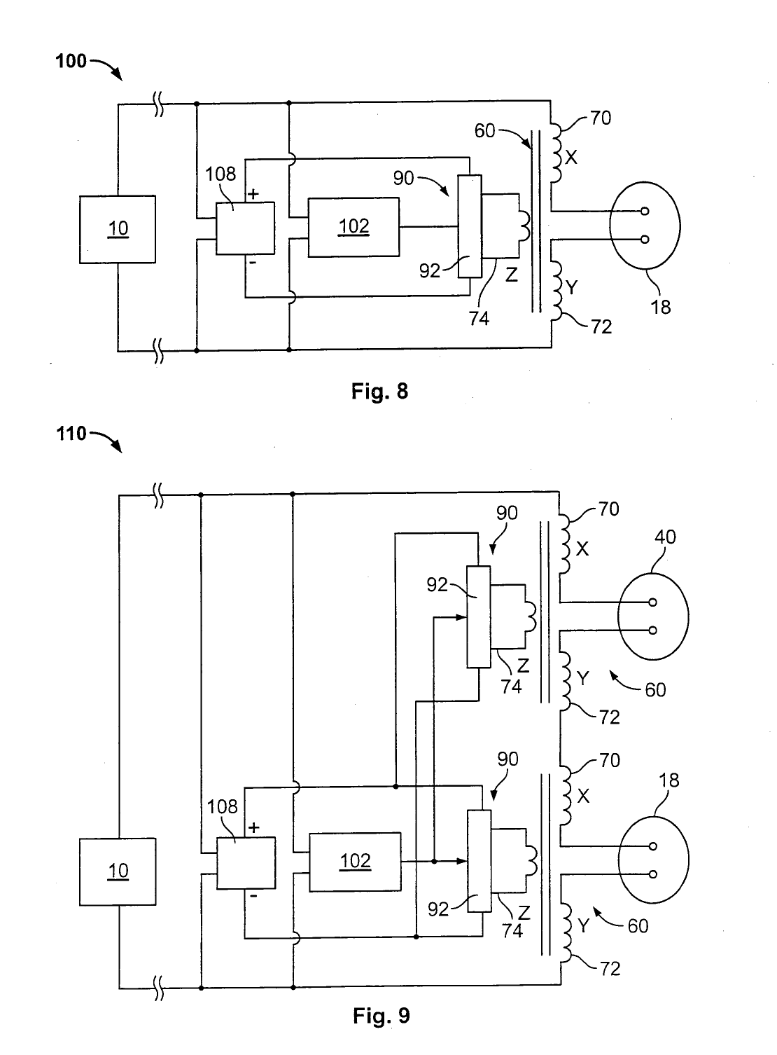

FIG. 8 shows a schematic view of a gas discharge lamp assembly according to a fourth embodiment of the invention;

FIG. 9 shows a schematic view of a gas discharge lamp assembly according to a fifth embodiment of the invention;

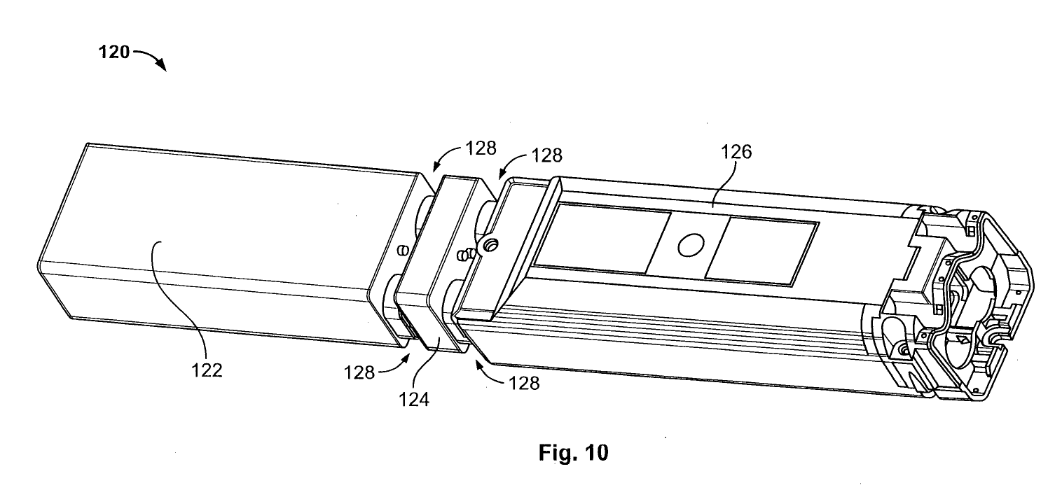

FIG. 10 shows a modular control gear according to a sixth embodiment of the invention;

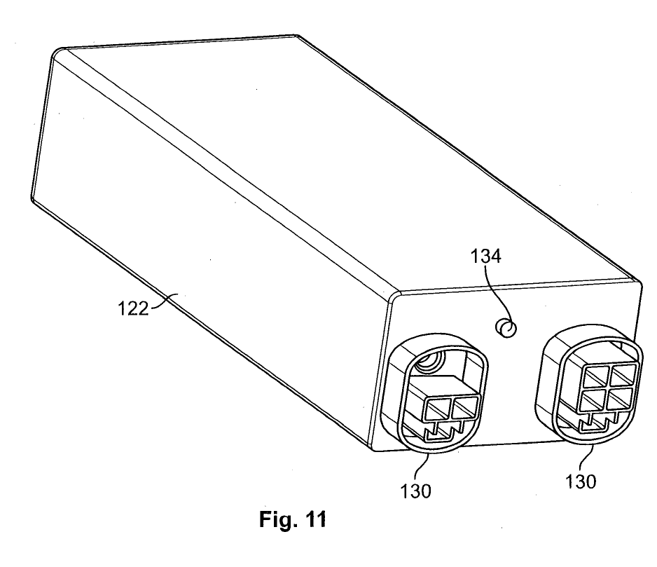

FIG. 11 shows a first housing forming part of the modular control gear shown in FIG. 10;

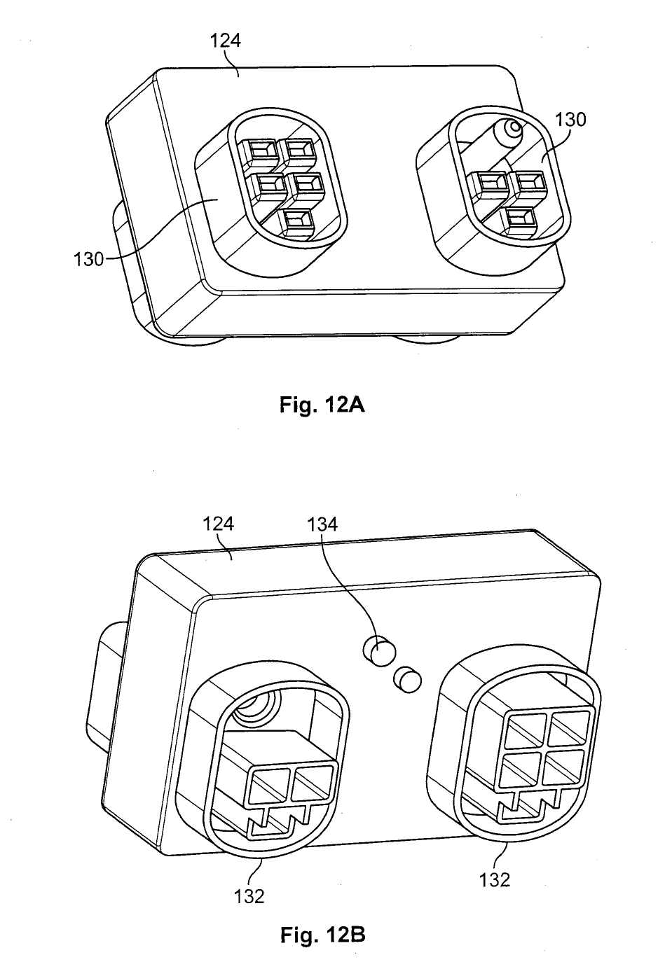

FIG. 12(a) shows a first view of a second housing forming part of the modular control gear shown in FIG. 10; and

FIG. 12(b) shows a second view, opposite the first, of the second housing shown in FIG. 12(a).

An electronic ballast according to a first embodiment of the invention is designated generally by the reference numeral 10.

The electronic ballast 10 comprises a unidirectional power conditioner 12 which includes a constant current source 14 and a switch 16. The switch 16 is electrically couplable, as shown in FIGS. 2 and 4, to a gas discharge lamp 18. The electronic ballast 10 may be located adjacent to the discharge lamp, as shown, in a so-called one-part arrangement.

The switch 16 defines a first conducting path CP1 through which current flows in a first direction D1, and a second conducting path CP2 through which the current flows in a second direction D2.

Each conducting path CP1, CP2 includes a pair of series-connected one-way switching devices 20, 22, 24, 26. In the embodiment shown each of the one-way switching devices 20, 22, 24, 26 is a field effect transistor (FET). In other embodiments of the invention (not shown) one or more of the one-way switching devices 20, 22, 24, 26 may include an insulated gate bipolar transistor (IGBT).

The one-way switching devices 20, 22, 24, 26 are arranged in a H-bridge configuration. A discharge lamp 18 is directly couplable to the one-way switching devices 20, 22, 24, 26 so as to bridge the first and second conducting paths CP1, CP2.

The power conditioner 12 includes a power converter circuit 28, to convert an alternating current into a direct current, an energy store 30 such as a capacitor, and a power correction circuit (not shown).

The power converter circuit 28 may include a constant current source circuit 32, as shown in FIG. 3. The constant current source circuit 32 shown includes an inductor 34, a diode 36, and a transistor 38, although other components are also possible.

The ballast 10 also includes a controller (not shown) to control the magnitude of the current provided by the constant current source 14. One form of suitable controller is a microcontroller.

The controller is driven by a modular control algorithm including first and second parts. The first part relates to generic control functions and the second part relates to discharge lamp 18 specific control functions.

The controller also includes a voltage measurement device (not shown) to measure the voltage across the discharge lamp 18, a current measuring device (not shown) to measure the current supplied to the discharge lamp 18, a power calculator (not shown) to calculate the average power dissipated in the discharge lamp 18, and a comparator (not shown) to compare the average power of the discharge lamp with a required lamp power.

The electronic ballast 10 further includes a visual indicator (not shown) to indicate an operational status of the ballast 10.

In use, a first pair of one-way switching devices 20, 26 are closed (while a second pair of one-way switching devices 22, 24 remain open) to complete the first conducting path CP1 and direct current from the constant current source 14 through the discharge lamp 18 in the first direction D1.

A predetermined period of time later the first pair of one-way switching devices 20, 26 are opened to break the first conducting path CP1, while the second pair of one-way switching devices 22, 24 are closed to complete the second conducting path CP2 and direction current from the constant current source 14 through the discharge lamp 18 in the second direction D2.

Alternative operation of the first and second pairs of one-way switching devices selectively directs current from the constant current source 14 through the discharge lamp 18 in the first and second directions D1, D2.

Thus the discharge lamp 18 is supplied with a constant current square wave with essentially instantaneous switching of the current flow between the first and second directions D1, D2 which results in the current supplied to the discharge lamp 18 being substantially continuous and having no net direct current component.

The controller monitors the average power supplied to the discharge lamp 18 and adjusts the magnitude of the current provided by the constant current source 14 to achieve the required lamp power, i.e. brightness.

The electronic ballast 10 is also directly couplable to a first discharge lamp 18 and a second discharge lamp 40 connected in series therewith, the discharge lamps 18, 40 being directly couplable to the one-way switching devices 20, 22, 24, 26 so as to bridge the first and second conducting paths CP1, CP2.

In use, alternative operation of the first 20, 26 and second 22, 24 pairs of one-way switching devices selectively directs current from the constant current source 14 through the discharge lamps 18, 52 in the first and second directions D1, D2.

The foregoing arrangement is possible because of the provision of a substantially constant current which is unaffected by the voltage across each discharge lamp 18, 40.

Since the power entering each discharge lamp 18, 40 will be proportional to its voltage rating, it is desirable that the first and second lamps 18, 40 have similar characteristics.

Nevertheless, it is possible to drive any combination of discharge lamps 18, 40, and indeed more than two such discharge lamps.

The electronic ballast 10 may include a controller which controls the magnitude of the current provided by the constant current source 14, and includes a frequency controller (not shown) to control the frequency at which the switch 16 switches between directing the current through the or each discharge lamp 18, 40 in the first and second directions D1, D2.

The frequency controller preferably causes the switch 16 to switch at a frequency falling within the range 5Hz to 300 Hz, and more particularly to switch at a first lower frequency in the range 5 to 6 Hz, and a second higher frequency in the range 20 to 300 Hz.

A transformer according to a second embodiment of the invention is designated generally by the reference numeral 70, as shown in FIG. 6.

The transformer 60 includes a core 62 that has interconnected legs 64, 66, 68, each of which includes a magnetic circuit.

The transformer 60 also includes a first secondary winding 70 around the first leg 64, a second secondary winding 72 around the second leg 66, and a primary winding 74 around the third leg 68.

The primary winding 74 is positioned between the first and second secondary windings 70, 72, and the first secondary winding 70 is wound in an opposite sense to the second secondary winding 72.

The transformer 60 includes printed windings 76 which form a multilayer Printed Circuit Board (PCB) 78.

Each layer of the PCB 78 includes first, second, and third apertures 80, 82, 84 through which the first, second, third legs 64, 66, 68 of the core 62 pass.

In an alternative embodiment (not shown) the transformer 60 may be constructed using conventional transformer winding techniques.

In use, flux from the primary winding 74 divides between the first and second legs 64, 66, and flow in an opposite direction in each of the first and second legs 64, 66.

The flux flow in the first and second legs 64, 66 is such that when the first and second secondary windings 70, 72 are connected in series via a series connection the resulting secondary voltages add, and when a current is supplied externally to the said series connection, fluxes in the first and second legs 64, 66 cancel, thereby reducing the effective inductance of the first and second secondary windings 70, 72 relative to that of each secondary winding 70, 72 taken separately.

An igniter for a gas discharge lamp according to a third embodiment of the invention is designated generally by the reference numeral 90.

The igniter 90 includes a transformer 60 and a drive circuit 92 to drive the primary winding 74 of the transformer 60. The first and second secondary windings 70, 72 of the transformer 60 are electrically couplable in series with a discharge lamp 18, 52 as shown, for example, in FIGS. 4 and 5.

During an ignition stage the drive circuit 92 applies a high current pulse to the primary winding 74. The flux produced in the core 62 passes through the first leg 64 in a first direction and through the second leg 66 in an opposite direction, and the resulting voltages across the secondary windings 70, 72 reinforce one another to provide the high voltage needed to establish an arc and ignite the corresponding discharge lamp 18, 52.

Typically the drive circuit 92 applies a succession of high current pulses, or a sine wave to the primary winding 74.

During normal operation of the discharge lamp 18, 52 the current supplied to the discharge lamp 18, 52 by the constant current source 14 flows through the first and second secondary windings 70, 72. The fluxes in the first and second legs 64, 66 generated by this current cancel one another, and so reduce the effective inductance of the secondary windings 70, 72. This helps to ensure that the switching of the current form the constant current source 14 through a discharge lamp 18, 52 is not degraded or slowed down, and thereby maintains the power supplied to the discharge lamp 18, 52 at a constant level.

A gas discharge lamp assembly according to a fourth embodiment of the invention is designated generally by the reference numeral 100, as shown in FIG. 8.

The gas discharge lamp assembly 100 includes an electronic ballast 10 which is electrically coupled directly with a first discharge lamp 18 that has a corresponding igniter 90 associated therewith. The igniter 90 receives power from the ballast 10 via a bridge rectifier 108. The ballast 10 and the discharge lamp 18 are spaced from one another in a, so-called, two-part arrangement.

In other embodiments of the invention the ballast 10 and the discharge lamp 18 may be arranged adjacent to one another in a one-part arrangement.

In the embodiment shown, the ballast 10 includes a controller having a frequency controller to control the frequency at which the switch 16 switches between directing the current from the constant current source 14 through the discharge lamp 18 in the first and second directions D1, D2.

The frequency controller causes the switch 16 to switch at a first lower frequency in the range 5 to 6 Hz, and a second higher frequency in the range 20 to 300 Hz.

The gas discharge lamp assembly 100 also includes a frequency discriminator 102, and an igniter controller (not shown) to inhibit ignition of the discharge lamp 18 until lapse of a predetermined time interval after prior extinguishing of the discharge lamp 18.

The gas discharge lamp assembly 100 may also include a modem 104 which is adapted to communicate with other devices or modems. In particular, the modem 104 may be configured to allow communication for the purposes of receiving or sending information to be interpreted and/or translated or converted into numerous industry standard protocols and signal levels e.g. DALI, RS-485, RS-232, Power Line Communication (PLC) and radio signalling, for example.

The modem 104 may allow the gas discharge lamp assembly 100 to receive command instruction via an onboard infrared communication port interface 106 for the purpose of controlling the power, i.e. brightness, of the discharge lamp 18.

The gas discharge lamp assembly 100 may also be capable of receiving 0 to 10 volt DC control input signals via an input port from third party equipment or systems to control the power, i.e. brightness, of the discharge lamp 18.

During an ignition stage the frequency controller causes the switch 16 to switch the current through the discharge lamp 18 at the first lower frequency. The frequency discriminator 102 senses the switching frequency and activates the drive circuit 92 in the igniter 90, so as to generate a high voltage across the discharge lamp 18 in order to establish an arc.

Once an arc has been established and detected by the controller, the frequency controller will cause the switch 16 to switch the current through the discharge lamp 18 at the second higher frequency. The frequency discriminator 102 senses the differing switching frequency and deactivates the drive circuit 92 in the igniter 90.

In this way it is possible to use the switching frequency of the current supplied by the constant current source to the discharge lamp 18 to control the igniter 90, thereby obviating the need for an additional control wire between the controller, i.e. ballast, and the igniter 90.

In other embodiments of the invention the frequency controller and the frequency discriminator may operate in reverse with a higher switching frequency causing the frequency discriminator to active the drive circuit 92.

A gas discharge lamp assembly according to a fifth embodiment of the invention is designated generally by the reference numeral 110, as shown in FIG. 9.

The second gas discharge lamp assembly 110 is similar to the first gas discharge assembly 100 and identical features share the same reference numeral.

The second gas discharge lamp assembly 110 includes an electronic ballast 10 which is electrically coupled directly with a first discharge lamp 18 and a second discharge lamp 40. Each of the discharge lamps 18, 40 has a corresponding igniter 90 associated therewith. The ballast 10 and the discharge lamps 18, 40 are spaced from one another in a two-part arrangement.

Operation of the second gas discharge lamp assembly 110 is essentially the same as with the first gas discharge assembly 100, but the frequency discriminator 102 simultaneously actives the drive circuit 92 of each igniter 90, as required.

A modular control gear according to a sixth embodiment of the invention is designated generally by the reference numeral 120.

The modular control gear 120 includes a plurality of components (not shown) each of which is contained within an individual housing 122, 124, 126. Each housing 122, 124, 126 has at least one connector 128 which is mutually engagable with a corresponding connector 128 of another housing 122, 124, 126.

In the embodiment shown the modular control gear 120 includes a first housing 122 containing an electronic ballast 10, a second housing 124 containing a modem 104, and a third housing 126 containing a fuse box.

The first housing 122 includes a pair of male connectors 130, while the second housing 124 includes a pair of male connectors 130 and a pair of female connectors 132, and the third housing 126 includes a pair of female connectors 132.

The male and female connectors 130, 132 are electrically couplable with one another and so permit the forming of a desired control gear by selecting particular first, second and/or third housings 122, 124, 126, as required.

Each housing 122, 124, 126 includes a visual indicator 134 to indicate an operational status of the component contained therein.

1. An electronic ballast, for a gas discharge lamp, comprising a unidirectional power conditioner including a constant current source and a switch, the switch being electrically couplable directly with at least one discharge lamp to selectively direct current from the constant current source through the or each discharge lamp in a first direction and a second direction, the first and second directions being opposite one another.

2. An electronic ballast according to claim 1 wherein the switch defines a first conducting path through which the current flows in the first direction and a second conducting path through which the current flows in the second direction.

3. An electronic ballast according to claim 2 wherein each conducting path includes a pair of series connected one-way switching devices.

4. An electronic ballast according to claim 3 wherein each one-way switching device includes a Field Effect Transistor (FET).

5. An electronic ballast according to claim 3 wherein each one-way switching device includes an Insulated Gate Bipolar Transistor (IGBT).

6. An electronic ballast according to claim 3 wherein the one-way switching devices are arranged in a H-bridge configuration to which the or each discharge lamp is directly couplable so as to bridge the first and second conducting paths.

7. An electronic ballast according to claim 1 wherein the power conditioner includes a power converter circuit to convert an alternating current into a direct current.

8. An electronic ballast according to claim 7 wherein the power converter circuit further includes an energy store.

9. An electronic ballast according to claim 7 wherein the power converter circuit further includes a power factor correction circuit.

10. An electronic ballast according to claim 1 further including a controller to control at least one of:
(i) the magnitude of the current provided by the constant current source; and
(ii) the frequency at which the switch switches between directing the current through the or each discharge lamp in the first and second directions.

11. An electronic ballast according to claim 10 wherein the controller is driven by a modular control algorithm.

12. An electronic ballast according to claim 11 wherein the modular control algorithm includes first and second parts, the first part relating to generic control functions, and the second part relating to discharge lamp specific control functions.

13. An electronic ballast according to claim 10 wherein the controller includes a voltage measurement device to measure the voltage across the or each discharge lamp, and a current measuring device to measure the current supplied to the or each discharge lamp.

14. An electronic ballast according to claim 13 wherein the controller further includes a power calculator to calculate the average power dissipated in the or each lamp, a comparator for comparing the average power of the or each lamp with a required lamp power, the controller adjusting magnitude of the current provided by the constant current source to achieve the required lamp power.

15. An electronic ballast according to claim 10 wherein the controller includes a frequency controller to control the frequency at which the switch switches between the positive and negative polarities.

16. An electronic ballast according to claim 15 wherein the frequency controller causes the switch to switch at a frequency falling within the range 5 Hz to 300 Hz.

17. An electronic ballast according to claim 15 wherein the frequency controller causes the switch to switch at a first lower frequency, and a second higher frequency.

18. An electronic ballast according to claim 17 wherein the lower frequency is in the range of 5 to 6 Hz, and the higher frequency is in the range 20 to 300 Hz.

19. An electronic ballast according to claim 1 including an indicator to indicate an operational status of the ballast.

20. An electronic ballast according to claim 19 wherein the indicator includes a visual indicator.

21. A transformer, for use in an igniter for a gas discharge lamp, comprising:
a core having interconnected legs, each leg comprising a magnetic circuit;
a first secondary winding around a first leg;
a second secondary winding around a second leg; and
a primary winding around a third leg,
the primary winding being positioned relative to the first and second secondary windings such that flux from the primary winding divides between the first and second legs and flows in a direction in each of the first and second legs such that when the first and second secondary windings are connected in series via a series connection the resulting secondary voltages add, and when a current is supplied externally to the said series connection, fluxes in the first and second legs cancel, thereby reducing the effective inductance of the first and second secondary windings relative to that of each secondary winding taken separately.

22. A transformer according to claim 21 wherein the first secondary winding is wound in an opposite sense to the second secondary winding.

23. A transformer according to claim 21 comprising printed windings forming a multilayer PCB, each layer of the multilayer PCB having a first, second and third aperture through which the first, second and third legs of the core respectively pass.

24. An igniter for a gas discharge lamp comprising a transformer according to claim 21 and a drive circuit for driving the primary winding, the first and second secondary windings of the transformer being electrically couplable in series with a discharge lamp.

25. A gas discharge lamp assembly comprising an electronic ballast comprising a unidirectional power conditioner including a constant current source and a switch, and at least one discharge lamp, the switch being electrically coupled directly with the at least one discharge lamp to selectively direct current from the constant current source in a first direction and a second direction, the first and second directions being opposite one another; and the or each discharge lamp having a corresponding igniter electrically coupled therewith.

26. A gas discharge lamp assembly according to claim 25 wherein the electronic ballast is electrically coupled to a plurality of series-connected discharge lamps.

27. A gas discharge lamp assembly according to claim 25 wherein the electronic ballast and the or each discharge lamp are arranged adjacent to one another.

28. A gas discharge lamp assembly according to claim 25 wherein the electronic ballast and the or each discharge lamp are spaced from one another.

29. A gas discharge lamp assembly according to claim 28 further including a frequency discriminator to sense the frequency at which the switch is switching the current supplied by the constant current source and activate the or each igniter only when a desired switching frequency is sensed.

30. A gas discharge lamp assembly according to claim 25 further including an igniter controller to inhibit ignition of a discharge lamp until lapse of a predetermined time interval after prior extinguishing of the discharge lamp.

31. A gas discharge lamp assembly according to claim 25 wherein the or each igniter is an igniter according claim 24.

32. A modular control gear for a gas discharge lamp comprising a plurality of components, each of the components being contained within an individual housing having at least one connector, the or each connector of one housing being mutually engagable with a corresponding connector of another housing, whereby one component is electrically couplable with another component to form a desired control gear for controlling a gas discharge lamp.

33. A modular control gear according to claim 32 wherein each housing includes an indicator to indicate an operational status of the component contained therein.

34. A modular control gear according to claim 32 wherein each indicator includes a visual indicator.
